(19) United States
(12) Patent Application Publication
(10) Pub. No.: US 2022/0405261 A1
(43) Pub. Date: Dec. 22, 2022

(54) SYSTEM AND METHOD TO EVALUATE DATA CONDITION FOR DATA ANALYTICS

(71) Applicant: International Business Machines Corporation, Armonk, NY (US)

(72) Inventors: Yi-Hui Ma, Mechanicsburg, PA (US); Eugene Irving Kelton, Wake Forest, NC (US); Willie Robert Patten, JR., Hurdle Mills, NC (US)

(21) Appl. No.: 17/354,572

(22) Filed: Jun. 22, 2021

(51) Int. Cl. G06F 16/22; G06F 16/2457

(52) U.S. Cl. CPC G06F 16/2272; G06F 16/24575

(57) ABSTRACT

A system, program product, and/or method for evaluating the condition of data for using data analytics options that includes: collecting data to evaluate its condition for supporting a plurality of data analytics options; determining, for each data analytics option, a plurality of a group of data indices, the group consisting of: a volume index measuring the amount of data, a history index for measuring the amount of historical data, a variety index for measuring the variety and type of data, a veracity index for measuring the quality of the data, a value index for measuring the information gain provided by the data; and determining a data readiness score that encompasses scaling, for each of the data analytics options, the plurality of the data indices group. Utilizing a data requirements matrix, providing domain-specific business objectives, and calculating for each of the data analytics options the information gain is also disclosed.

### BACKGROUND

The present application relates generally to information handling and/or data processing and analytics, and more particularly to evaluating and/or checking the condition and health of data for purposes of using data analytics and making recommendations on which data analytics to apply based at least in part upon the condition and health of the data.

Data analytics have shown promising results in helping financial institutions across different segments to perform risk assessment, including for example fraud detection. Generally, in risk assessment, fraud detection, and/or anti-money laundering (AML) cases there are numerous and different parameters, factors, and metrics in large data sets that are analyzed and used to build advanced data analytical and/or machine learning (ML) models. Often, whether data analytics can be applied, and/or the data analytics options to apply, will in large part be a function of the condition of the data that is available for analysis. In addition, in risk assessment, AML, and/or fraud detection, raw data often needs to be transformed and/or manipulated before advanced data analytics can be applied. In many cases the results of advanced data analytics is a function of how good the data is, is the data the right type, is there the right amount of data, is the data in the right form, etc. It would be advantageous to quantify data quality preferably before data analytics is deployed to provide a check and evaluation on the condition of the data to determine whether advanced data analytics, e.g., machine learning and/or deep learning, can be applied, so unnecessary data processing can be reduced, and recommendations can be made on the advanced data analytics to apply based at least in part upon the condition of the data, so proper advanced data analytics can be performed. The ability to track the condition of data over a period of time would also be beneficial.

### SUMMARY

The summary of the disclosure is given to aid understanding of, and not with an intent to limit the disclosure. The present disclosure is directed to a person of ordinary skill in the art. It should be understood that various aspects and features of the disclosure may advantageously be used separately in some circumstances or instances, or in combination with other aspects, embodiments, and/or features of the disclosure in other circumstances or instances. Accordingly, variations and modifications may be made to the system, method, and/or computer program product to achieve different effects. In this regard, it will be appreciated that the disclosure presents and describes one or more inventions, and in aspects includes numerous inventions as defined by the claims.

A system, method and/or computer program product is disclosed according to one or more embodiments for evaluating the condition of data for purposes of applying data analytics, and in aspects for providing recommendations on which data analytic options and/or models to apply based at least in part on the condition of the data, and in further aspects making recommendations and/or assessments based upon domain specific criteria including for example the desired end use, e.g., for risk assessment in insurance claim processing.

A system, computer program product, and/or method for evaluating the condition of data for purposes of applying data analytics options is disclosed that includes: collecting data to evaluate a condition of the data for supporting a plurality of data analytics options; determining, for each data analytics option, a plurality of a group of data indices, the group consisting of: a volume index measuring the amount of data for meaningful analysis and model building, a history index for measuring the amount of historical data available to capture necessary cycle data, a variety index for measuring the variety and type of data, a veracity index for measuring the quality of the data, a value index for measuring the information gain provided by the data, and combinations thereof; and determining a data readiness score, wherein determining the data readiness score encompasses scaling, for each of the data analytics options, the plurality of the group of data indices. In a further approach, the system, computer program product, and/or method includes determining, for each data analytics option, all the plurality of the group of data indices; and determining the data readiness score based upon scaling, for each data analytics options, all the plurality of the group of data indices. A data readiness report is generated in an embodiment that includes the data readiness score, and in an aspect the data readiness report is generated by a Data Readiness Module, and optionally includes the plurality of the group of data indices.

The system, computer program product, and/or method in an embodiment further includes preparing one or more insights based upon the plurality of the group of data indices, and in an aspect including the one or more insights in the data readiness report. In a further aspect, the system, computer program product, and/or method includes preparing one or more visual aids for the plurality of the group of data indices, and in an aspect including the one or more visual aids in the data readiness report. According to one or more embodiments, the system, computer-program, and/or method includes preparing, for at least one of the group of data indices, one or more insights; preparing, for at least one of the group of data indices, one or more visual aids; and including in the data readiness report at least one of the one or more insights or the one or more visual aids.

In a further aspect, the system, computer program product, and/or method utilizes a data requirements matrix which sets forth for each of the plurality of data analytics options the minimum threshold data requirements for each of the group of data indices. According to a further approach, the system, computer program product, and/or method includes providing domain specific business objectives to account for a potential value of each of the plurality of data analytics options; and calculating, for each of the plurality of data analytics options, the information gain. In an embodiment, providing domain specific business objectives to account for the potential value of each of the plurality of data analytics options includes applying, for each of the plurality of data analytics options, a scaling factor to one or more of the group of data indices. Calculating, for each of the plurality of data analytics options, the information gain includes in an aspect accounting, for each data analytics option, the minimum threshold data requirements and the scaling factor for each of the group of data indices. The system, computer program product, and/or method further includes according to an embodiment, monitoring and graphing the data readiness score over a time period; and monitoring and graphing each of the data indices over the time period.

The computer program product in one or more embodiments can include instructions that are embedded on and/or stored in a non-transitory computer readable medium that, when executed by at least one hardware processor, configure the at least one hardware processor to perform the operations specified above and discussed in this disclosure. The system according to an aspect can include a memory storage device storing program instructions; and a hardware processor coupled to said memory storage device, the hardware processor, in response to executing said program instructions, is configured to perform the operations specified above and discussed in this disclosure.

The foregoing and other objects, features, and/or advantages of the invention will be apparent from the following more particular descriptions and exemplary embodiments of the invention as illustrated in the accompanying drawings wherein like reference numbers generally represent like parts of the illustrative embodiments of the invention.

### BRIEF DESCRIPTION OF THE DRAWINGS

The various aspects, features, and embodiments of a computer implemented system, method, and/or computer program product to evaluate the condition of data for data analytics, to use the data condition evaluation to make recommendations on the type of data analytics to implement, and/or in an aspect to monitor the condition of the data for improvement, will be better understood when read in conjunction with the figures provided. Embodiments are provided in the figures for the purpose of illustrating aspects, features, and/or various embodiments of the systems and methods, but the claims should not be limited to the precise arrangement, structures, features, aspects, systems, modules, functional units, circuitry, embodiments, methods, processes, techniques, instructions, programming, and/or devices shown, and the arrangements, structures, features, aspects, systems, modules, functional units, circuitry, embodiments, methods, processes, techniques, instructions, programming, and devices shown may be used singularly or in combination with other arrangements, structures, systems, modules, functional units, features, aspects, circuitry, embodiments, methods, techniques, processes, instructions, programming, and/or devices.

FIG. 1 schematically illustrates an exemplary computer system in accordance with the present disclosure to evaluate the condition of data for advanced data analytics, to make recommendations on the type of advanced analytics to implement; and/or in an aspect to monitor the condition of the data over time;

FIG. 2 schematically illustrates an exemplary computer system/computing device which is applicable to implement one or more embodiments of the present disclosure to perform a health check and evaluate the condition of data for purposes of applying advanced data analytics, in an aspect to make recommendations on the advanced data analytics to implement based at least in part upon the condition of the data, and in a further optional aspect to monitor and/or track the condition of the data;

FIG. 3 schematically illustrates a simplified block diagram of a Data Readiness Module communicating with an Analytic Recommendation Module according to an embodiment of the present disclosure;

FIG. 4 diagrammatically illustrates a simplified block diagram of a Data Readiness Module according to an embodiment of the present disclosure;

FIG. 5 diagrammatically illustrates in accordance with an embodiment of the present disclosure operations of a Data Readiness Module to determine a data readiness score;

FIG. 6 diagrammatically illustrates in accordance with an example of the present disclosure a data readiness report;

FIG. 7 diagrammatically illustrates in accordance with an example of the present disclosure operations of an Analytic Recommendation Module to provide an analytic option report;

FIG. 8 illustrates in accordance with an example of the present disclosure a requirement matrix table;

FIG. 9 illustrates in accordance with an example of the present disclosure a key metrics monitoring chart;

FIG. 10 illustrates in accordance with an example of the present disclosure a chart tracking the progress of analytical options and data readiness score;

FIG. 11 illustrates a diagrammatic flowchart of a method according to an embodiment of the present disclosure of evaluating the condition of data for purposes of applying data analytics;

FIG. 12 illustrates a diagrammatic flowchart of a method according to an embodiment of the present disclosure of optimizing the condition of data and/or making recommendations on the analytic options to implement based at least in part on the condition of the data, and further monitoring the condition of data over a period of time; and

FIG. 13 illustrates a diagrammatic flowchart of a method according to an embodiment of the present disclosure of performing a data readiness evaluation and making recommendations on the advanced data analytics to apply based at least in part on the condition of the data.

### DETAILED DESCRIPTION

The following description is made for illustrating the general principles of the invention and is not meant to limit the inventive concepts claimed herein. In the following detailed description, numerous details are set forth in order to provide an understanding of the system, method, and/or techniques for evaluating the condition of data for data analytics, to make recommendations on the data analytics to apply based at least in part on the condition of the data; and in a further optional aspect to monitor the condition of the data over a period of time. It will be understood, however, by those skilled in the art that different and numerous embodiments of the system and its method of operation may be practiced without the specific details, and the claims and disclosure should not be limited to the arrangements, structures, systems, modules, functional units, circuitry, embodiments, features, aspects, processes, methods, techniques, instructions, programming, and/or details specifically described and shown herein. Further, particular features, aspects, arrangements, structures, systems, modules, functional units, circuitry, embodiments, methods, processes, techniques, instructions, programming, details, etc. described herein can be used in combination with other described features, aspects, arrangements, structures, systems, modules, functional units, circuitry, embodiments, techniques, methods, processes, instructions, programming, details, etc. in each of the various possible combinations and permutations.

The following discussion omits or only briefly describes conventional features of information processing systems and data networks, including electronic advanced data analytics programs or electronic risk assessment tools configured and adapted for example to detect suspicious activity and/or problematic transactions in connection with, for example, financial transactions and/or insurance claim transactions, which should be apparent to those skilled in the art. It is assumed that those skilled in the art are familiar with data processing including large scale data processing (also referred to as information/data processing systems) and their operation, and implementation and application of advanced data analytics, including data analytics systems and processes using, for example, machine learning (ML) models. The advanced data analytics can include supervised or unsupervised machine learning (ML), Clustering, Pattern Detection, Entity Resolution, Anomaly, Graph Analytic, and Counter Party, to name just a few. It may be noted that a numbered element is numbered according to the figure in which the element is introduced, and is typically referred to by that number throughout succeeding figures.

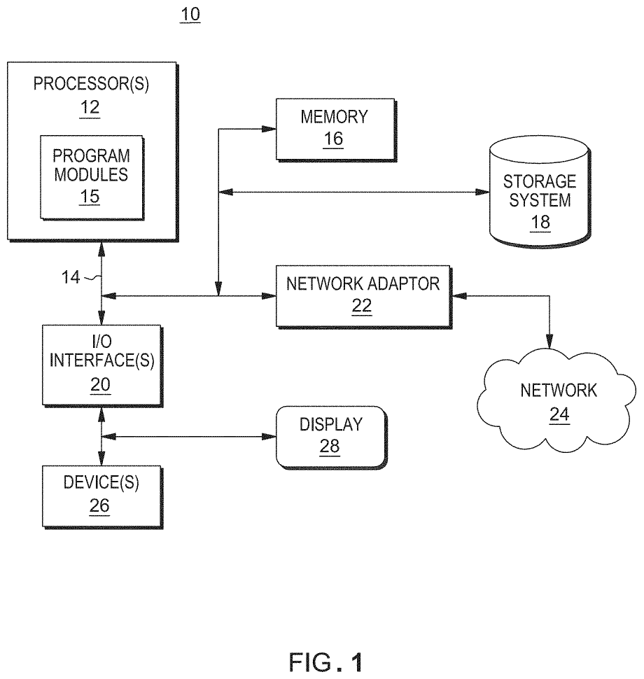

FIG. 1 illustrates an example computing system 10 in accordance with the present invention. It is to be understood that the computer system depicted is only one example of a suitable electronic data processing and/or data analytics system and is not intended to suggest any limitation as to the scope of use or functionality of embodiments of the present invention.

For example, the system shown may be operational with numerous other computing system environments or configurations, including special-purpose computing systems. Examples of well-known computing systems, environments, and/or configurations that may be suitable for use with the system shown in FIG. 1 may include, but are not limited to, personal computer systems, server computer systems, thin clients, thick clients, handheld or laptop devices, tablets, smart phones, multiprocessor systems, microprocessor-based systems, set top boxes, programmable consumer electronics, network PCs, minicomputer systems, mainframe computer systems, and distributed cloud computing environments that include any of the disclosed systems or devices, and the like.

In some embodiments, the computer system 10 may be described in the general context of computer system executable instructions, embodied as program modules or software programs stored in memory 16, being executed by the computer system. Generally, program modules may include routines, programs, objects, components, logic, data structures, and so on that perform particular tasks and/or implement particular input data and/or data types in accordance with the present invention.

The components of the computer system 10 may include, but are not limited to, one or more processors or processing units 12, a memory 16, and a bus 14 that operably couples various system components, including memory 16 to processor 12. In some embodiments, the processor 12 may execute one or more program modules 15 that are loaded from memory 16, where the program module(s) embody software (program instructions) that cause the processor to perform one or more method embodiments of the present invention. In some embodiments, program module 15, e.g., software programs, may be programmed into the circuits of the processor 12, loaded from memory 16, storage device 18, network 24 and/or combinations thereof. It is generally appreciated that processor 12 contains circuits including integrated circuits to perform operations of the processor 12.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer system 10 may include a variety of computer system readable media. Such media may be any available media that is accessible by the computer system, and it may include both volatile and non-volatile media, removable and non-removable media. Memory 16 (sometimes referred to as system memory) can include computer readable media in the form of volatile memory, such as random access memory (RAM), cache memory and/or other forms. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

The computer system 10 may also communicate with one or more external devices 26 such as a keyboard, a pointing device, a display 28, etc.; one or more devices that enable a user to interact with the computer system; and/or any devices (e.g., network card, modem, etc.) that enable the computer system to communicate with one or more other computing devices. Such communication can occur via Input/Output (I/O) interfaces 20.

Still yet, the computer system 10 can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with the computer system. Examples include, but are not limited to: microcode, device drivers, redundant processing units, external disk-drive arrays, RAID systems, tape drives, and data archival storage systems, etc.

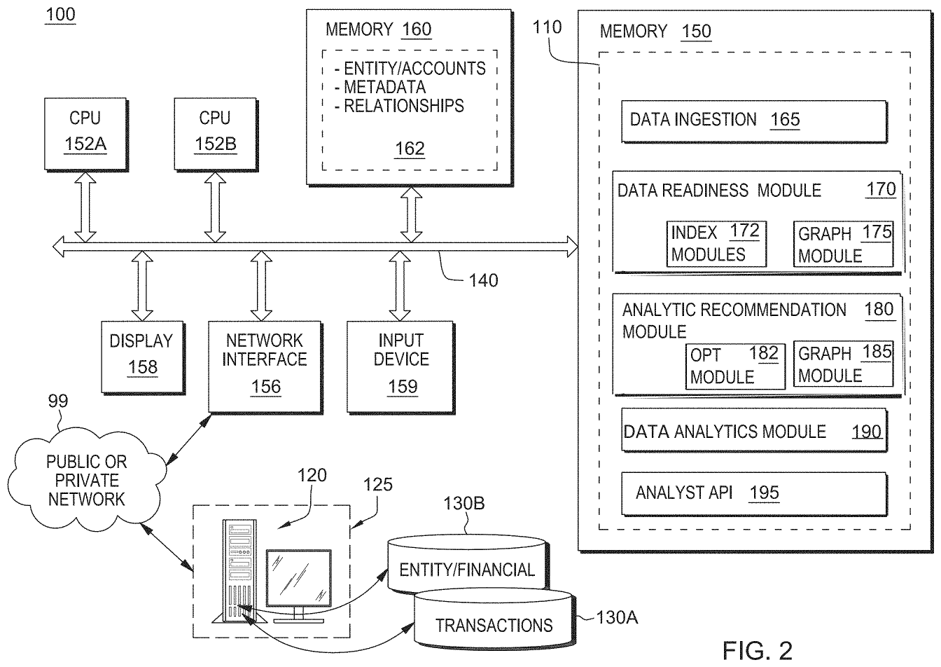

FIG. 2 illustrates a computer system 100 configured and programmed to evaluate the condition of data for use in advanced data analytics, for example, for use in detecting suspicious, problematic, risky, and/or fraudulent transactions in the domain of financial services, insurance claims processing, and related industries, e.g., transaction risk assessment, loan/mortgage processing, insurance claim fraud, money laundering, and/or fraud detection. In embodiments, such a system 100 may be employed by or for a financial institution or insurance company. According to an embodiment, system 100 is a computer system, a computing device, a mobile device, or a server configured to run risk assessment, fraudulent detection, money laundering, and/or other software applications and models. In some aspects, computer system/device 100 can include, for example, mainframe computers, servers, distributed cloud computing environments, thin clients, thick clients, personal computers, PC networks, laptops, tablets, mini-computers, multiprocessor based systems, micro-processor based systems, smart devices, smart phones, set-top boxes, programmable electronics, or any other similar computing device, an embodiment of which is described in more detail in FIG. 1.

Computing system 100 includes one or more hardware processors 152A, 152B (also referred to as central processing units (CPUs)), a memory 150, e.g., for storing an operating system, application program interfaces (APIs) and programs, a network interface 156, a display device 158, an input device 159, and any other features common to a computing device. Further, as shown as part of system 100, there is provided a local memory and/or an attached memory storage device 160, or a remote memory storage device, e.g., a database, accessible via a remote network connection for input to the system 100.

In some aspects, computing system 100 may, for example, be any computing device that is configured to communicate with one or more web-sites 125 including a web-based or cloud-based server 120 over a public or private communications network 99. For instance, a web-site may include a financial institution that records/stores information, e.g., multiple financial transactions occurring between numerous parties (entities), loan processing, insurance claim processing and/or electronic transactions. Such loan processing, insurance claim processing, and/or electronic transactions may be stored in a database 130A with associated financial and entity information stored in related database 130B.

In the embodiment depicted in FIG. 2, processors 152A, 152B may include, for example, a microcontroller, Field Programmable Gate Array (FPGA), or any other processor that is configured to perform various operations. Communication channels 140, e.g., wired connections such as data bus lines, address bus lines, Input/Output (I/O) data lines, video bus, expansion busses, etc., are shown for routing signals between the various components of system 100. Processors 152A, 152B are configured to execute instructions, e.g., programming instructions, as described below. These instructions may be stored, for example, as programmed modules in memory storage device 150.

Network interface 156 is configured to transmit and receive data or information to and from a web-site server 120, e.g., via wired or wireless connections. For example, network interface 156 may utilize wireless technologies and communication protocols such as Bluetooth®, WIFI (e.g., 802.11a/b/g/n), cellular networks (e.g., CDMA, GSM, M2M, and 3G/4G/4G LTE, 5G), near-field communications systems, satellite communications, via a local area network (LAN), via a wide area network (WAN), or any other form of communication that allows computing device 100 to transmit information to or receive information from the server 120.

Display 158 may include, for example, a computer monitor, television, smart television, a display screen integrated into a personal computing device such as, for example, laptops, smart phones, smart watches, virtual reality headsets, smart wearable devices, or any other mechanism for displaying information to a user. In some aspects, display 158 may include a liquid crystal display (LCD), an e-paper/e-ink display, an organic LED (OLED) display, or other similar display technologies. In some aspects, display 158 may be touch-sensitive and may also function as an input device.

Input device 159 may include, for example, a keyboard, a mouse, a touch-sensitive display, a keypad, a microphone, or other similar input devices or any other input devices that may be used alone or together to provide a user with the capability to interact with the computing device 100.

Memory 150 may include, for example, non-transitory computer readable media in the form of volatile memory, such as random access memory (RAM) and/or cache memory or others. Memory 150 may include, for example, other removable/non-removable, volatile/non-volatile storage media. By way of non-limiting examples only, memory 150 may include a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Memory 150 of computer system 100 stores one or more processing modules that include, for example, programmed instructions adapted to evaluate the condition and health of data for purposes of using data analytics, making recommendations on which advanced data analytics options to implement, and/or monitor the condition of the data over time, to, for example, perform risk assessment, anti-money laundering (AML), and/or fraud detection. In one embodiment, one of the programmed processing modules stored at the associated memory 150 includes a data ingestion module 165 that provide instructions and logic for operating circuitry to access/read large amounts of data (e.g., parties, accounts, transactions, claims, events, etc.) for use by other modules that process and analyze the data to access its condition, make recommendations on optimized data analytics to implement, and/or monitor the condition of the data in, for example, the context of risk assessment, AML, and fraud detection cases.

In one or more embodiments, the input data for data ingestion module 165 comprises parties, accounts, transactions, claims, events, payment history, etc. For example, where a financial institution, such as for example a bank, desires to determine if there is a transaction risk or determine the risk of a money laundering scheme or other fraud, the input data can comprise: the transactions occurring with or being processed by the financial institution; the parties to any financial transaction with or through the financial institution; account information (the customers) of the financial institution, the present status or state of any financial transaction, etc. In the case of an insurance organization and the like, the input data can comprise: the parties doing business with the insurance organization; the claims made with the insurance organization; policy information; the status of the current claim; the identity of any agencies or brokers that were involved in underwriting the policy; and/or any parties involved in treating the claim, e.g., auto body shop fixing the motor vehicle, physician treating patient, etc. The examples above are not limiting and there can be other situations where the system will have application, and additional or other input data can be provided.

As indicated earlier, the results of advanced data analytics is only as good as the data used in implementing and applying the advanced data analytics. In addition, raw data input to systems to run advanced data analytics often needs to be transformed and/or manipulated before the data analytics can be applied. It would be advantageous to know before running the advanced analytics the condition of the data, and whether it is appropriate for the desired data analytics to be implemented, to recommend the data analytics that can be implemented based at least in part upon the condition of the data, to optimize the implemented data analytics, and/or to monitor the condition of the data over time.

In one or more embodiments, a quantitative and/or systematic way to perform an overall data health check is disclosed that facilitates the data readiness for applying recommended advanced data analytics is disclosed, preferably advanced data analytics for risk assessment including fraud detection. The data health check is preferably automated and includes not only data quality exploration, but also in one or more embodiments domain-specific data requirement checks. In an embodiment, the data health check and evaluation generates a data readiness report, and in an aspect the information obtained from and/or the data readiness report itself can be used to invoke an analytic recommendation module. In a further aspect the analytic recommendation module and/or information in the data readiness report can be used to monitor, track, and/or check the condition of the data over a period of time, including monitoring for future data improvement or deterioration.

In one or more embodiments, a system, computer program product, and/or method of evaluating data readiness is provided, preferably with a comprehensive framework and/or platform. The disclosed system, method, and/or computer program product provides in one or more embodiments a quantitative metric to provide an overall score on the condition of the data, and in a further aspect generate a data health report. In an embodiment, a system, computer program product, and/or method utilizes data readiness metric(s) in prioritizing and/or recommending data analytic options. The system, computer program product, and/or method, including in an embodiment the data readiness report, provides quantitative insights on the data's condition and readiness for advanced analytics and machine learning, provides actionable recommendations for optimized data analytics deployment, and/or in a further aspect provides ongoing monitoring of the data quality to proactively identify data issues. In one or more embodiments, based upon on available data quality and availability, an optimized recommendation can be determined on the type of data analytics to deploy. Each analytic requires a different level/type of data and provides a different contribution to the overall solution. In an aspect, optimized evaluations of candidate analytics is generated, such that the candidate analytic with higher gain will be the data analytic that satisfies the necessary data requirement (has sufficient data to run the analytics) and provides maximum information gain. The system and/or method can in embodiments be integrated into offerings such as IBM Watson Studio Local (WSL) including Data Refinery, and Auto-AI, allowing for broad applications and implementations.

In an embodiment, a Data Readiness Module 170 is included in the system 100, e.g., in memory 150, and provides instructions and logic for operating circuitry to evaluate the condition of data and in an aspect provide a data readiness report that can provide in an embodiment an overall data readiness score with key metrics and insights. In one or more embodiments, the Data Readiness Module 170 receives the data ingested by Data Ingestion Module 165 and prepares a data readiness report that in an embodiment provides a data readiness score for the data, which in an aspect includes key metrics and insights. The Data Readiness Module 170 contains one or more Index Modules 172, described in more detail in FIGS. 4 & 5, that evaluate one or more different parameters, factors, indices, and/or metrics measuring the condition of the data.

Data Readiness Module 170 in an aspect further contains Graphics Module 175 that in an embodiment contains one or more graphics programs that provides instructions and logic for operating circuits to access, read, generate, and/or build one or more graphs, charts and other visual aids to facilitate review of the data health check results. While the Graphics Module 175 is shown as being within the Data Readiness Module 170, it can be appreciated that the Graphics Module 175 can be a separate module in memory 150, and/or a module within Analytic Recommendation Module 180 and/or within Data Analytics Module 190.

In an embodiment, an Analytic Recommendation Module 180 is included in the system 100, e.g., in memory 150, and provides instructions and logic for operating circuitry to provide recommendations for data analytics deployment, preferably to optimize implementation of data analytics for the desired tasks and results. In one or more embodiments, the Analytic Recommendation Module 180 receives a data readiness report from the Data Readiness Module 170 and uses information in the data readiness report to provide recommendations on which data analytics to run on the data to provide optimized results. In one or more embodiments, the Analytic Recommendation Module 180 further provides and/or generates an analytic requirement matrix. In a further embodiment, Analytic Recommendation Module 180 provides ongoing monitoring of the data quality to proactively identify potential issues and concerns with the input data, and in an aspect creates control charts to monitor and track data improvement, progression, and/or deterioration. The Analytic Recommendation Module 180 in an embodiment contains an Optimization (“OPT”) Module 182 to recommend data analytics to implement to obtain optimized results.

Analytic Recommendation Module 180 in an aspect further contains Graphics Module 185 that in an embodiment contains one or more graphics programs that provides instructions and logic for operating circuits to access, read, generate and/or build one or more graphs, charts and other visual aids to facilitate monitoring and tracking the condition of the data, e.g., monitor and/or tracking the data readiness score, including the various data index scores. While the Graphics Module 185 is shown as being within the Analytic Recommendation Module 180, it can be appreciated that the Graphics Module 185 can be a separate module in memory 150, and/or a module within Data Readiness Module 170 and/or within Data Analytics Module 190.

In one or more embodiments, system 100, e.g., memory 150, contains a Data Analytics Module 190 that contains one or more data analytics modules and/or software programs that provides instructions and logic for operating circuits to analyze data. The data analytics modules and/or programs in Data Analytics Module 190 can include, for example, Entity Resolution, Clustering, Supervised ML, Anomaly, Graph Analytic, and/or Counter Party to name a few. Entity Resolution clarifies records and removes ambiguity associated with entity identification. Clustering assigns parties to homogeneous groupings. Supervised ML calculates risk associated with each party based upon historical data. Anomaly identifies potential abnormal pattern through peer similarity. Graph Analytic evaluates risk through network structure. Counter Party analyzes the relationship and impact between party and counter party.

The data analytics modules can be used to, for example, assess risk, AML, and/or fraud detection. The data analytics modules and/or programs, in one or more embodiments, leverage cognitive capabilities. A cognitive system (sometimes referred to as deep learning, deep thought, or deep question answering) is a form of artificial intelligence that uses machine learning and problem solving. A modern implementation of artificial intelligence (AI) is the IBM Watson cognitive technology. Models for scoring and ranking an answer can be trained on the basis of large sets of input data. The more algorithms that find the same answer independently, the more likely that answer is correct, resulting in an overall score or confidence level. Cognitive systems are generally known in the art.

Data Analytic Module 190 for example can include a probabilistic risk model to determine a transaction risk probability based on the variables or features of the transaction and metadata. Module 190 can invoke a ML Model to perform supervised (or unsupervised) machine learning techniques for detecting business risk (including detecting suspicious activity indicative of criminal activity, e.g., fraud), as known in the art, e.g., supervised learning using a regression model to predict a value of input data (classification) and unsupervised learning (clustering) techniques. Based on features and metadata, techniques employing Hidden Markov Models or Artificial Neural Networks may alternatively or additionally be employed to compute a risk associated with the particular party/transaction. The result of the machine learning model in an embodiment can be the computing of a risk “weight” or score attributed to the particular party or transaction.

Data Analytic Module 190 can also include a Risk-by-Association analyzer employing logic and instructions for performing a Risk-by-Association analysis based upon associations found in the data. For example, in the context of financial fraud detection, the Risk-by-Association analysis performed is used to establish “suspicion” of an entity based on “associations” or “patterns” in the data. Such analysis methods can employ one or more risk-by-association machine learned methods and/or models: Random Walk with Restarts (RW), Semi-Supervised Learning (SSL), and Belief Propagation (BP), as known in the art. Such risk-by-association method(s) and/or model(s) results in computing a risk-by-association score. Based on the computed Risk-by-Association analysis score, an alert and/or suspicious activity report (SAR) can be produced, and an analyst can analyze the alert and/or SARs and provide feedback as to a potential risk level of a party and/or transaction.

Data Analytic Module 190 can also include a pattern determination/detection module employing logic and instructions for detecting any data patterns indicative of risk and/or fraud in a transaction. The pattern detection module in an embodiment reads data and detects patterns of behavior or activity. The pattern detection module implements logic and program circuitry to receive input configuration data, receive training data, historic data, current data, and/or actual live data to detect data patterns. In one or more embodiments the pattern determination module leverages cognitive capabilities. Several data analytics modules and programs have been described, however, other data analytics modules are contemplated as included within system 100, e.g., in memory 150.

Memory 150 optionally includes a supervisory program having instructions for configuring the computing system 100 to call one or more, and in an embodiment all, of the program modules and invoke the operations of system 100. In an embodiment, such supervisory program calls methods and provides application program interfaces for running the Data Readiness Module 170, the Analytic Recommendation Module 180, and/or optionally the Data Analytics Module 190. At least one application program interface 195 is invoked in an embodiment to receive input data from a “user”. Via API 195, the user inputs data or has data files and sets loaded into Data Readiness Module 170. The Data Readiness Module 170 in an embodiment produces and/or generates a result which can be reviewed by the user. The result or portions thereof can also be received and further processed by the Analytic Recommendation Module 180 automatically or manually by the user.

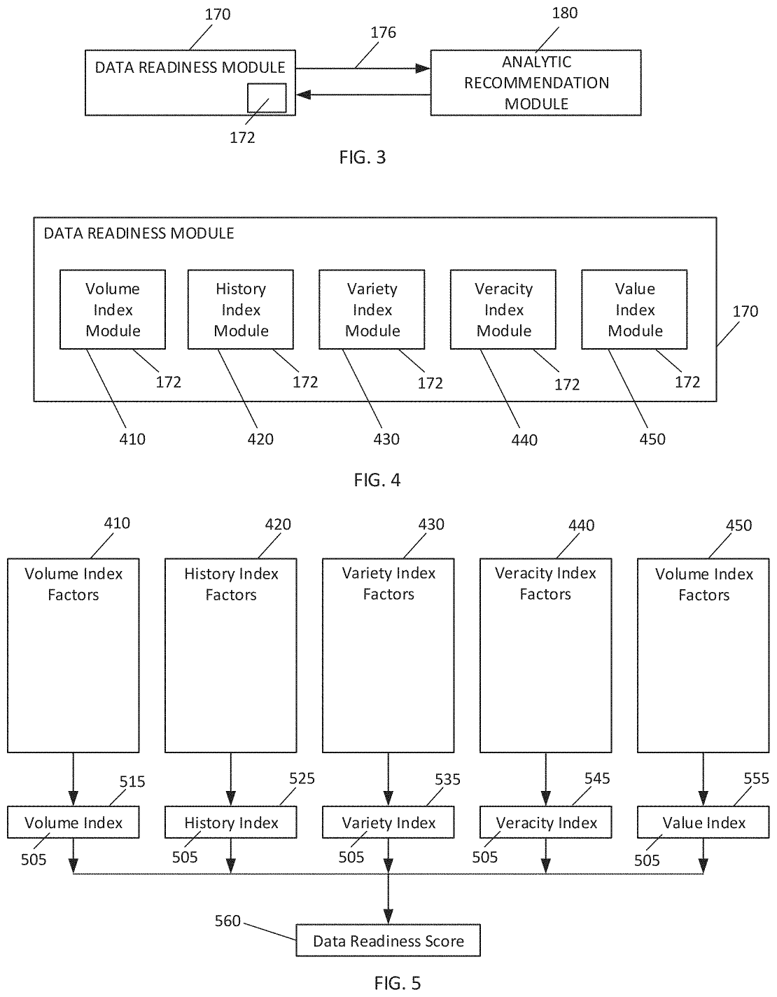

FIG. 3 illustrates the Data Readiness Module 170 providing output 176, for example data readiness information, to Analytic Recommendation Module 180. As shown in FIG. 3, Analytic Recommendation Module 180 can communicate and provide information and/or feedback to Data Readiness Module 170. Data Readiness Module 170 includes Index Modules 172 that measure various parameters and/or metrics regarding the data that indicate the readiness of the data for various advanced data analytics. In the embodiment of FIG. 4, five Index Modules 172 are shown, including Volume Index Module 410, History Index Module 420, Variety Index Module 430, Veracity Index Module 440, and Value Index Module 450 in Data Readiness Module 170. Each Index Module 172 typically will review metadata associated with the data, and in many instances will review and evaluate different metadata for each Index Module 172, e.g., Index Modules 410, 420, 430, 440, 450.

Each Index Module 172 as shown in FIG. 5 provides an index or score 505 that provides a determination and/or evaluation of the data readiness for that particular metric. The index or score 505 could be high, medium, or low, or other categorization. The index or score 505 could also be a numerical number or percentage based score. As shown in FIG. 5, each data metric index 505 is used to calculate a data readiness index or score 560. The data readiness index or score 560 can be a numerical number and/or percentage, and/or can be an index or categorization, e.g., low, medium, or high.

Volume Index Module 410 determines whether there is enough volume of data to provide a meaningful analysis and model building. Volume Index Module 410 generates a volume index 515 that is used to measure and/or score the volume of data for advanced analytics. In one or more embodiments, the Volume Index Module 410 considers volume index factors including, for example, the number of customers, the number of parties, the number of accounts, the number of transactions, the number of alerts, the number of suspicious activity reports (SARs), and/or the number of counter parties. Other information can be used in Volume Index Module 410 to determine a volume index 515 for the data.

History Index Module 420 determines how much historical data is available to capture necessary or pertinent time cycles and/or time frames. History Index Module 420 generates a history index 525 that is used to measure and/or score the data history for advanced analytics. In one or more embodiments, the History Index Module 420 considers history index factors including, for example, the data time coverage, the frequency of updates, known seasonality of the data, the time series, and/or population stability. Other information can be used in History Index Module 420 to determine a history index 525 for the data.

Variety Index Module 430 determines whether the data includes structured or unstructured data type, and/or internal or external data type. Variety Index Module 430 generates a variety index 535 that is used to measure and/or score the variety of data, and more specifically in an embodiment whether the proper data is available for advanced analytics. In one or more embodiments, the Variety Index Module 430 considers variety index factors including, for example, numerical fields, categorical fields, key identifiers, unstructured text field, table linkage, whether data is external or internal data type, and/or whether data is personal information/personal identifiable information (PII). Other information can be used in Variety Index Module 430 to determine a variety index 535 for the data.

Veracity Index Module 440 determines the data quality, for example, its inconsistency, messiness, and/or incompleteness. Veracity Index Module 440 generates a veracity index 545 that is used to measure and/or score the quality of the data for use in advanced data analytics. In one or more embodiments, the Veracity Index Module 440 considers veracity index factors including, for example, definition tables, special characters, duplication, completion percentage, data distribution, unstructured parsing, data consistency, and/or default logic. Other information can be used in Veracity Index Module 440 to determine a veracity index 545 for the data.

Value Index Module 450 determines what data, e.g., what data fields, provide the most information gain for use in data analytics. Value Index Module 450 generates a value index 555 that is used to measure and/or score the value of data for advanced analytics. In one or more embodiments, the Value Index Module 450 considers value index factors, including, for example, information gain, correlation, alert scenarios, segmentation options, rules, constraints, and/or party-to-party flow. Other information can be used in Value Index Module 450 to determine a value index 555 for the data.

In one or more embodiments, the volume index 515, the history index 525, the variety index 535, the veracity index 545, and/or the value index 555 are used to generate a data readiness score or index 560. In an example, the data readiness score 560 is determined by weighting and scaling the various indexes 505 used to generate the data readiness score. In an aspect, the volume index 515, the history index 525, the variety index 535, the veracity index 545, and/or the value index 555 can be scaled so that each index 505 contributes a different amount to the data readiness score 560. In one or more embodiments, custom factors can be used to determine the weighting and importance of the various indices 505 in determining the data readiness score 560. Custom factors can take into account domain specific factors, for example, to scale and weight the various indices 505. For example, a first scaling factor (e.g., greater than 1.0) can be applied to a first index 505 (e.g., the volume index 515), while a different, second scaling factor (e.g., less than 1.0) can be applied to a second index 505 (e.g., the value index 555). That is, in an embodiment, the data readiness score 560 takes into account the domain in which the data analytics is being implemented. For example, fraud detection domain will take into account different index factors and weight the indices 505 differently than AML domain. In a further aspect, fraud detection in insurance claim processing domain may weigh the indices 505 differently than fraud detection in a bank transaction processing domain.

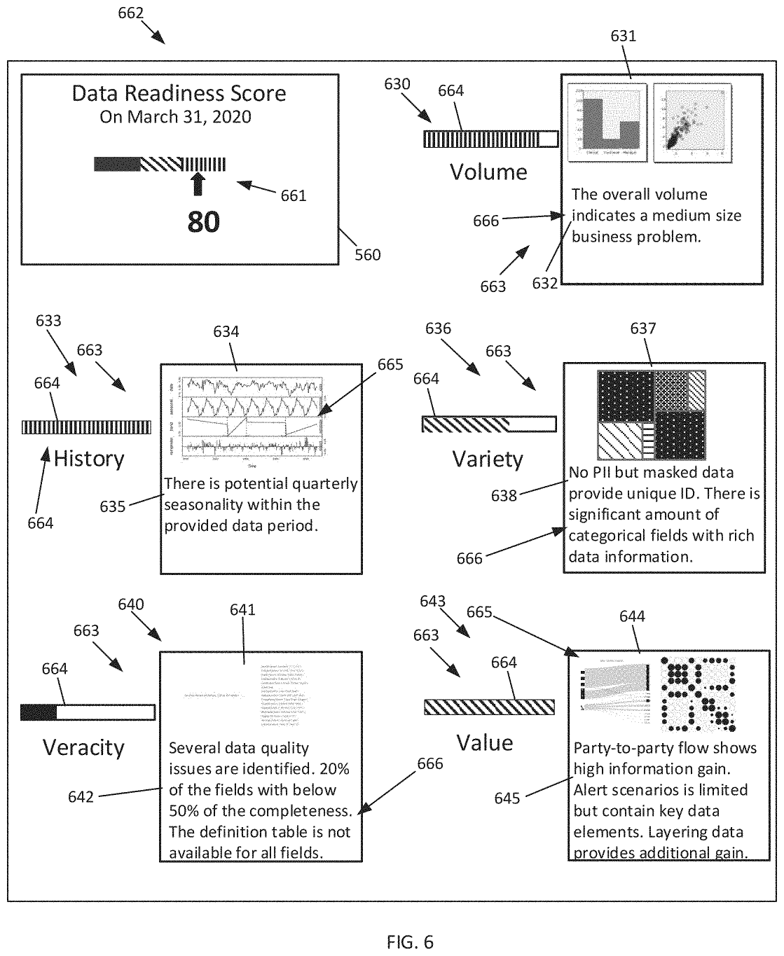

In a further embodiment, the data readiness score 560, and/or one or more of the indices 505, are used to produce a data readiness report 662 as shown in FIG. 6. The data readiness report 662 in an aspect includes key metrics and insights into the data and its ability to produce results using data analytics. In an embodiment, the data readiness report 662 includes charts and graphs that are used to explain the condition of the data, including text and graphs illustrating the key metrics 663, e.g., the volume index 515, the history index 525, the variety index 535, the veracity index 545, and/or the value index 555. As shown in FIG. 6, the data readiness report 662 includes the overall data readiness score 560 and a graphic 661 illustrating the overall data readiness score. The data readiness report 662 can also include a score for each key metric 663, e.g., the volume index 515, the history index 525, the variety index 535, the veracity index 545, and/or the value index 555, that makes up the data readiness score 560, and preferably includes a visual indicator 664 for each key metric score.

In a further embodiment, generation of the data readiness report 662 can further include a text box 666 providing insights into and/or describing the condition of the data as it applies to that metric 663, e.g., index factor 505. Generation of the data readiness report 662 in an aspect further includes generation of a chart and/or graphic 665 for each key metric 663 and/or insight 666 to visually demonstrate to the user the condition of that particular metric/index factor 663 and/or insight 666. Data readiness report 662 in one or more embodiments includes a Volume Metric portion 630 that can include volume index 515 and can also include graphic 631 and insights 632; History Metric portion 633 that can include history index 525 and can also include graphic 634 and insights 635; Variety Metric portion 636 that can include variety index 535 and can also include graphic 637 and insights 638; Veracity Metric portion 640 that can include veracity index 545 and can also include graphic 641 and insights 642, and Value Metric portion 643 that can include value index 555 and can also include graphic 644 and insights 645. Data readiness report can include more or less information than shown in FIG. 6.

As illustrated in FIG. 3, information 176 generated in Data Readiness Module 170 is output to Analytic Recommendation Module 180. Information 176 generated by Data Readiness Module 170 and/or received by Analytic Recommendation Module 180 can include, for example, data readiness score 460, data readiness report 462, volume index 415 (and associated metric 630, graphics 631, and insights 632), history index 425 (and associated metric 633, graphics 634, and insights 635), variety index 435 (and associated metric 636, graphics 637, and insights 638), veracity index 445 (and associated metric 640, graphics 641, and insights 642), value index 455 (and associated metric 643, graphics 644, and insights 645). Other information can be generated by Data Readiness Module 170 and/or received by Analytic Recommendation Module 180.

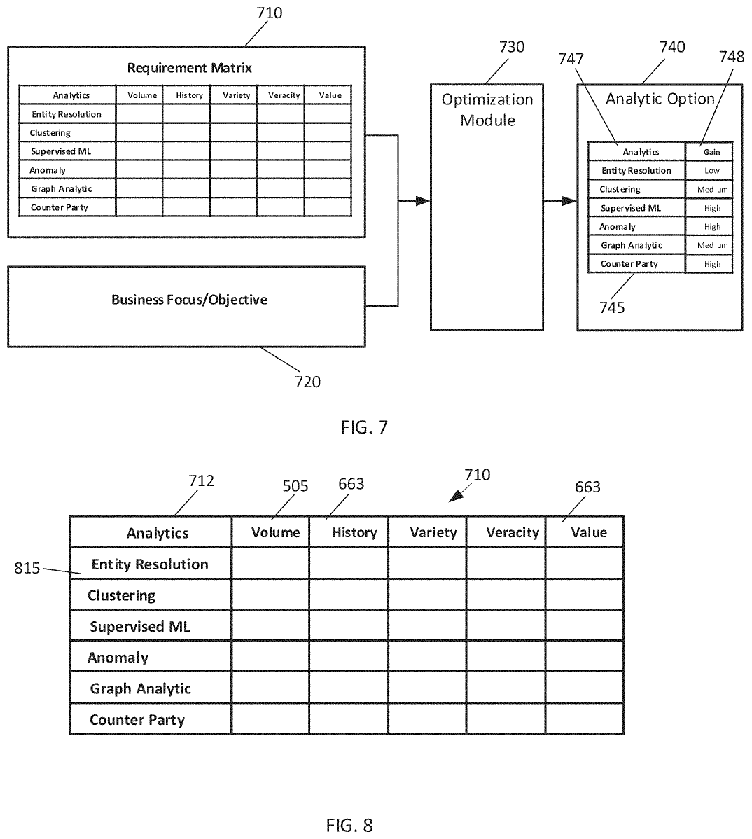

Analytic Recommendation Module 180 as shown in FIG. 7 generates a requirement matrix 710, which along with the business objective 720 is feed into an Optimization Module 730. Optimization Module 730 generates and outputs an Analytic Option analysis or report 740. An embodiment of the requirement matrix 710 is shown in more detail in FIG. 8, and can include a table 712 which sets forth the minimum data requirements for each index 505 and/or key metric 663 for each different type of data analytics option 815. More specifically, requirement matrix 710 in the form of requirement matrix table 712 identifies for each of the different types of data analytic modules or programs 815, e.g., Entity Resolution, Clustering, Supervised ML, Anomaly, Graph Analytic, and Counter Party, the minimum data requirements for each of the data indices 505 or key metrics 663, e.g., Volume metric 630, History metric 633, Variety metric 636, Veracity metric 640, and Value metric 643. That is the requirement matrix 710 (e.g., requirement matrix table 712) is established based upon the required input for each data analytic option and/or model. For example, for Entity Resolution names and other identification such as date of birth (DOB) and/or address are required. If that information is not available or is incomplete, attempting to run Entity Resolution would not yield very good results.

Domain specific and/or business focus and objectives 720, which takes into account, by using for example scaling factors, the potential value of different analytic models, are fed into Optimization Module 730 along with the requirement matrix 710. That is, different data analytic options and/or models could be more valuable in providing the desired analytics for the particular business problem being addressed. In an embodiment, the scaling factors and/or weights to be applied will be based upon SME and/or historical learning. In addition, different data analytic models can rely more heavily on different data indices 505, e.g., volume index, history index, variety index, veracity index, and value index, to obtain appropriate (e.g., confident) results. As such, scaling can be applied to account for the importance of different data analytic options/models to address the business concern. Scaling could also be applied to account for the different influence the different data indices can exert over the different data analytic options/models. Constraints and tradeoffs can also be applied to determine which data analytics would provide the best data analytics for the given business concern based upon the condition of the data.

Optimization Module 730 looks to maximize total information gain TG, and/or provide output that illustrates the information gain for each of the analytic options. In one or more embodiments, total information gain TG can be represented as:

TG=W₁X₁+W₂X₂+ . . . +WₘXₘ

where Wᵢ is the weighted information gain associated with analytic option i, and Xᵢ is a decision variable for analytic option i where Xᵢ is a binary (either 0, 1) to either take into account the weighted information gain of a particular analytic option or ignore/exclude it. The total information gain TG is subject to constraints and thresholds as follows: Σᵢ₌₁^{m}Σⱼ₌₁ⁿRᵢⱼXᵢ>=T, where T is a threshold for total requirement, Rᵢⱼ is requirement associated with analytic option i; and Vⱼ>=RᵢⱼXᵢ and Σᵢ₌₁^{m}Xᵢ<=N, where Vⱼ is calculated metric for V-index j, and N accounts for capacity constraints. The requirement matrix Rᵢⱼ provides the data requirement for each analytic option. The first constraint specifies the total data requirement across all “Active/Selected” (X=1) analytics. The second constraint ensures the calculated data index metric is higher than the requirement when the analytics is selected. The third constraint imposes maximum number of analytics to be selected.

The Optimization Module 730 preferably outputs an analytic option chart or table 745 that lists for each analytic option 747 the information gain 748 that would be obtained from using the specified analytic and using the data in its current form and state. A user can use the analytic option table 745 to determine which data analytic options will provide the best information gain.

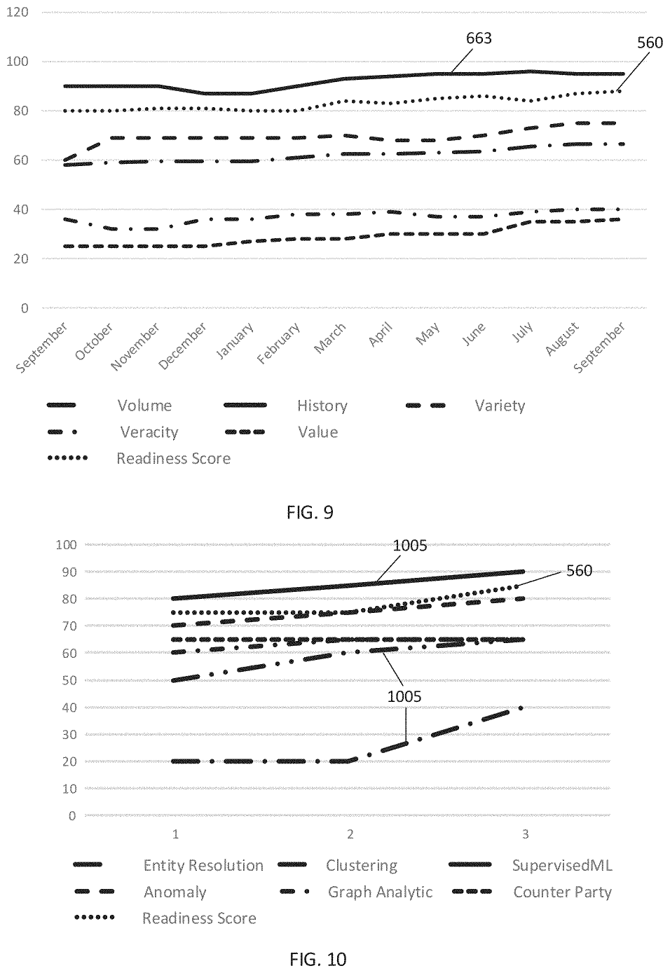

In a further aspect, the system, method, and/or computer program product can monitor and track the key metrics over time. In one or more embodiments, one or more of the key metrics 663 and/or indices 505 measuring the condition of the data can be tracked over time, and/or all the key metrics 663 can be tracked and plotted together, along with, for example, the total readiness score 560, on a chart as shown in FIG. 9. In FIG. 9, the volume index/metric, the history index/metric, the variety index/metric, the veracity index/metric, the value index/metric and the total readiness score are charted over time. In a further embodiment, the information gain 1005 provided by each analytic option, e.g., the analytic gain, can be tracked and plotted over time, along with, for example, the total readiness score, on a chart as shown in FIG. 10. For example, in FIG. 10 the information gain for the Entity Resolution analytic, the Clustering analytic, the supervised machine learning (ML) analytic, the Anomaly analytic, the Graph analytic and the Counter Party analytic are plotted over time as is the data readiness score. A user through use of the charts as illustrated in FIGS. 9 & 10 can track the progress of the condition of the data over time.

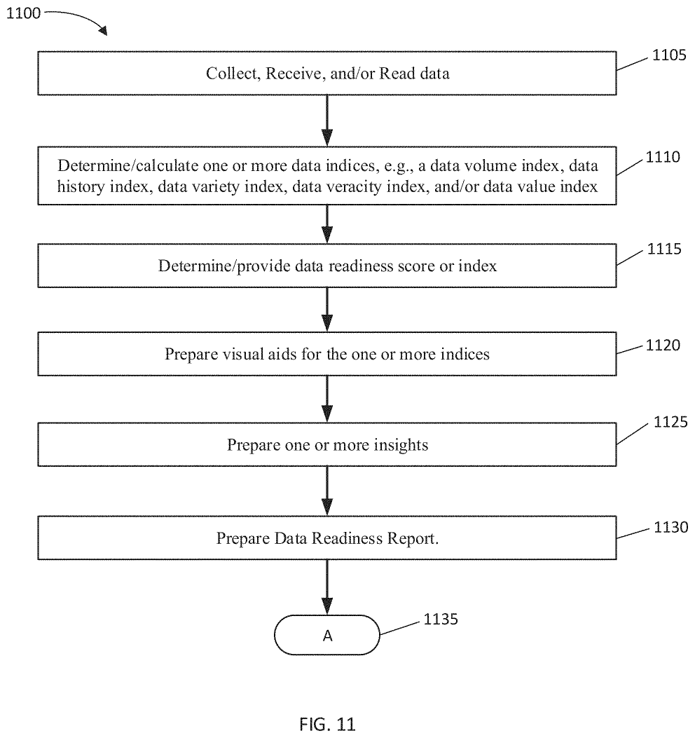

FIG. 11 is an exemplary flowchart in accordance with one embodiment illustrating and describing a method 1100 of evaluating the condition of data for running, deploying, and/or implementing one or more different types of data analytics, e.g., and in an embodiment generating a data readiness report or evaluation. While the method 1100 is described for the sake of convenience and not with an intent of limiting the disclosure as comprising a series and/or a number of steps, it is to be understood that the process does not need to be performed as a series of steps and/or the steps do not need to be performed in the order shown and described with respect to FIG. 11, but the process may be integrated and/or one or more steps may be performed together, simultaneously, or the steps may be performed in the order disclosed or in an alternate order.

In one or more aspects, the method 1100 includes at 1105 collecting data for evaluation to check its ability to support different types of data analytics. In one or more embodiments, collecting data at 1105 can include collecting customer data, party data, account data, transaction data, alerts, and/or suspicious activity reports (SARs). Collecting data at 1105 in one or more embodiments includes collecting metadata and/or metadata tags. At 1110 one or more data indices are determined. In an embodiment, a volume index, a history index, a variety index, a veracity index, and/or a value index is determined. Other data metrics can be considered and reviewed and corresponding indices determined and/or calculated.

At 1115 a data readiness score or index is determined. In an embodiment the data readiness score or index is determined based upon the one or more indices calculated and determined at 1110. In one or more aspects, the one or more data indices are scaled and weighted to determine the data readiness score. In an aspect, custom domain specific factors are taken into consideration when determining the data readiness score. That is, the context and/or reason for implementing the data analytics is used to scale or weight the data indices and/or calculate the data readiness score or index. It can be appreciated that the data readiness score or index can be calculated, generated and/or provided in a variety of manners. For example the data readiness score or index can be expressed as a number or range of numbers, and can be based upon a scale. For example, the data readiness score or index can be represented as a number, e.g. 85, out of a hundred, or as a range of numbers, e.g., 82-87, out of a hundred. In another example, the data readiness score can be expressed in bands of numbers or percentages, for example in bands or ranges of 10 percent, e.g., band 40%-50%, 50%-60%, etc. The data readiness score or index can also be expressed as a level or category, e.g., low, medium, or high. Other ways of expressing the data readiness score or index are contemplated.

At 1120 visual aids are created, generated, and/or prepared for example, for the overall data readiness score, and/or for example, for each of the metrics or factors used in calculating the data readiness score. The visual aids prepared and/or created at 1120 can include charts, maps, tables and other visual or graphic diagrams. In one or more embodiments the visual aids can be distribution charts, time series, network flow charts, tree maps, and/or radar charts. At 1120 visual aids, charts, diagrams, and/or charts can be created for each of the volume index/metric, the history index/metric, variety index/metric, veracity index/metric, and/or the value index/metric. In one or more embodiments a graph module, e.g., Graph Module 175, can be used to create, generate, and/or produce the graphs and/or visual aids at 1120.

At 1125 insights are optionally created, generated, and/or prepared for one or more of the metrics or factors used in calculating the data readiness score. The insights preferably provide information on the metric, factor, index to which it corresponds. Preferably insights are provided on key metrics. The insights can include recommendations and/or actions that can be taken, and/or how to improve the condition of the data. At 1130 a data readiness report is created, prepared, and/or generated. The data readiness report can include one or more of the data readiness score calculated at 1115, the visual aids generated and prepared at 1120, and the one or more insights generated and prepared at 1125. It can be appreciated that each of 1110, 1115, 1120, 1125, and 1130 can be associated with, and/or performed in or as a result of invoking Data Readiness Module 170.

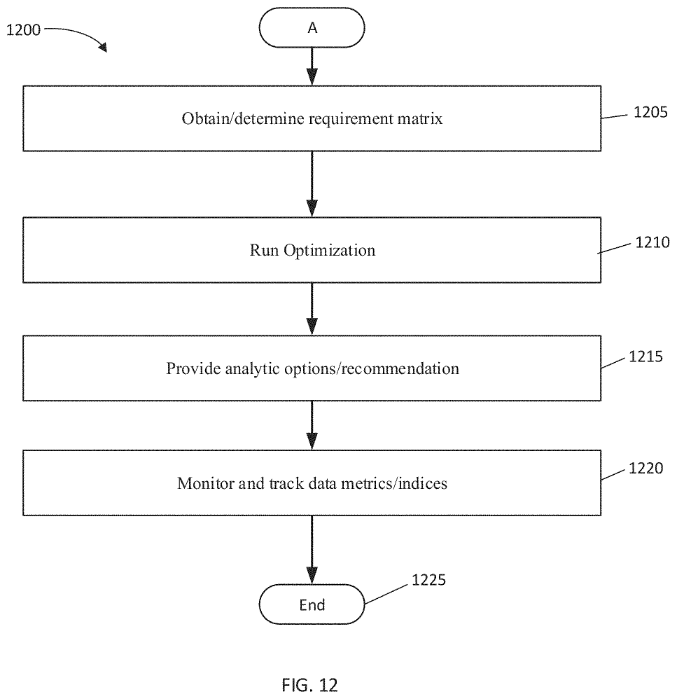

Process 1100 can end with the preparation of the data readiness report, or process 1100 can continue to 1135 where the data readiness report, and/or parts and information therein, will be used to provide one or more recommendations on the type of data analytics to implement, as will be described in more detail in connection with method 1200 in FIG. 12.

FIG. 12 is an exemplary flowchart in accordance with an embodiment illustrating and describing a method 1200 of recommending and in an aspect optimizing, the type of data analytics to implement based at least in part on the condition of the data, and in a further embodiment of monitoring and tracking the key metrics and indices measuring the condition of the data, and/or the information gain, e.g., the analytic gain. While the method 1200 is described for the sake of convenience and not with an intent of limiting the disclosure as comprising a series and/or a number of steps, it is to be understood that the process does not need to be performed as a series of steps and/or the steps do not need to be performed in the order shown and described with respect to FIG. 12, but the process may be integrated and/or one or more steps may be performed together, simultaneously, or the steps may be performed in the order disclosed or in an alternate order.

The process 1200 in one or more embodiments includes at 1205 obtaining and/or generating an analytic requirement matrix. The requirement matrix in one or more embodiments specifies for each of the one or more metrics, e.g., key metrics, the minimum data requirements for each different data analytics type. For example, the analytic requirement matrix would provide for each data analytic type, information on the minimum: (a) data volume requirements, (b) data history requirements, (c) data variety requirements, (d) data veracity requirements, and/or (e) data value requirements. The requirement matrix would include one or more, and preferably all the pertinent data analytic types, for example, supervised machine learning (ML), entity resolution, clustering, anomaly, graph analytic, and/or counter party.

Process 1200 would continue to 1210 where optimization, e.g., determining the optimal and/or best data analytic to use, would be performed. Optimization at 1210 can include taking into account the objective, context, and/or domain for which the data is being analyzed, and for what (the goals, objects, and/or reasons) implementing data analytics is to provide insights or information. For example, is the data being used to detect money laundering transactions or suspicious insurance claim processing. In this regard, different data analytics could be more valuable in providing the desired information. In addition, different data analytic models can rely more heavily on different data indices, e.g., volume index, history index, variety index, veracity index, and value index, to obtain more appropriate and trustworthy results. Scaling and weighing can be applied to account for the ability of different data analytic options/modules to provide the desired information relevant to the business objective, and scaling and weighing can be applied to account for the different influence and/or affect different data indices have over the data analytic options/models. So, for example, a data analytic option or model (e.g., machine learning) that is more important for the particular purpose of running the data analytics can be scaled at 1.2 while a less important data analytic option (e.g., anomaly) can be scaled to 0.8. In addition, if for a particular data analytic (e.g., machine learning), a specific data index (e.g., the volume index) is more important than another data index (e.g., veracity index), then the volume index can be scaled at a value over 1.0 (e.g., 1.3) while the veracity index can be scaled at a value under 1.0 (e.g., 0.6). Constraints and tradeoffs can also be applied to customize the results for the business objective. Constraints are conditions and/or limitations when seeking the solution. These constraints typically add boundaries to the solution space. For example, there may be some resource/time/data constraints that the solution cannot exceed. Tradeoffs are criteria that should be considered. For example, where the total cost is to be minimized or the revenue/information gain is to be maximized. There are also tradeoffs within each objective. For example, when choosing to maximize revenue, there might be different sources of revenue that are tradeoffs. Financial information such as, for example, costs and revenue, can be included in optimization at 1210. At 1215 the information gain that would be derived for each type of data analytic based upon the current condition of the data can be provided, calculated, determined, and/or generated. In an example, recommended analytic options can be provided to optimize the data analytic results.

At 1220 the metrics and indices measuring the condition of the data can be monitored and tracked, for example, over one or more periods of time. In an embodiment the key metrics measuring the condition of the data, e.g., the data volume index, the data history index, the data variety index, the data veracity index, and/or the data value index, are monitored and tracked. In one or more embodiments, control charts are provided and/or generated for the data readiness score and analytic (information) gain so that a user can keep an eye on the progression of the data, and preferably improve the data to obtain optimized data analytics. It can be appreciated that in one or more embodiments each of 1205, 1210, 1215, 1220, and/or 1225 can be associated with and/or performed in or as a result of invoking the Analytic Recommendation Module 180.

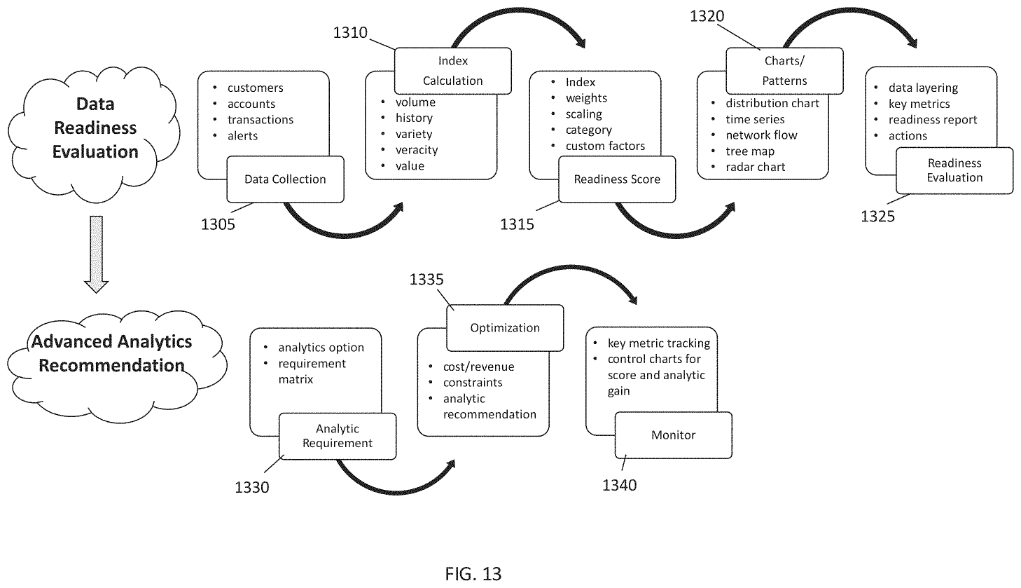

FIG. 13 is an exemplary flowchart in accordance with an embodiment illustrating and describing a method 1300 of evaluating the condition of data and providing a data readiness evaluation using for example a Data Readiness Module, and using the data readiness evaluation results to provide an advanced Analytics recommendation using for example an analytic Recommendation Module. While the method 1300 is described for the sake of convenience and not with an intent of limiting the disclosure as comprising a series and/or a number of steps, it is to be understood that the process does not need to be performed as a series of steps and/or the steps do not need to be performed in the order shown and described with respect to FIG. 13, but the process may be integrated and/or one or more steps may be performed together, simultaneously, or the steps may be performed in the order disclosed or in an alternate order.

In one or more aspects, the method 1300 includes at 1305 collecting, providing, and/or receiving data for evaluation to check its ability to support different types of data analytics. At 1310 one or more data indices are determined. In an embodiment, a volume index, a history index, a variety index, a veracity index, and/or a value index is determined at 1310. Other data metrics can be considered and reviewed and corresponding indices determined and/or calculated. At 1315 a data readiness score or index is determined. In an embodiment the data readiness score or index is determined based in part upon the one or more indices calculated and determined at 1310. At 1320 visual aids are created, generated, and/or prepared for example, for the overall data readiness score, and/or for example, for each of the metrics, factors, or indices used in calculating the data readiness score. At 1320 visual aids, charts, diagrams, and/or charts can be created for each of the data volume index/metric, the data history index/metric, the data variety index/metric, the data veracity index/metric, and/or the data value index/metric. At 1325 insights are created, generated, and/or prepared for one or more of the metrics or factors used in calculating the data readiness score and a data readiness report is created, prepared, and/or generated. It can be appreciated that each of 1310, 1315, 1320, and 1325 can be associated with, and/or performed in or as a result of invoking Data Readiness Module 170.

The process 1300 continues where the data readiness evaluation is used and or passed on to Analytic Recommendation Module 180 where in one or more embodiments at 1330 an analytic requirement matrix is received, obtained, and/or generated. The requirement matrix in one or more embodiments specifies for each of the one or more metrics, e.g., key metrics, the minimum data requirements for each different data analytics type. Process 1300 continues to 1335 where optimization would be performed. Optimization at 1335 can include taking into account the objective, context, and/or domain for which the data is being analyzed, and for which it will be applied. In this regard scaling and weighing can be applied as well as constraints and tradeoffs. In an example, recommended analytic options can be provided at 1335 to optimize the data analytic results. At 1340 the metrics and indices measuring the condition of the data can be monitored and tracked. In one or more embodiments, control charts are provided and/or generated for the data readiness score and analytic gain so that a user can keep an eye on the progression of the data, and preferably improve the data to obtain optimized data analytics. It can be appreciated that in one or more embodiments each of 1330, 1335, and/or 1340 can be associated with and/or performed in or as a result of invoking the Analytic Recommendation Module 180. In one or more embodiments, generation of a data readiness report can automatically invoke the Analytic Recommendation Module 180.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor, functional units of a processor, or computer implemented system, and logic integrated with and/or executable by the system, processor, or functional units, the logic being configured to perform one or more of the process steps cited herein. What is meant by integrated with is that in an embodiment the functional unit or processor has logic embedded therewith as hardware logic, such as an application specific integrated circuit (ASIC), a field programmable gate array (FPGA), etc. By executable by the functional unit or processor, what is meant is that the logic in an embodiment is hardware logic; software logic such as firmware, part of an operating system, part of an application program; etc., or some combination of hardware or software logic that is accessible by the functional unit or processor and configured to cause the functional unit or processor to perform some functionality upon execution by the functional unit or processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above. If will be further appreciated that embodiments of the present invention may be provided in the form of a service deployed on behalf of a customer to offer a service on demand.

The terminology used herein is for the purpose of describing particular embodiments only and is not intended to be limiting of the invention. Unless otherwise specifically defined herein, all terms are to be given their broadest possible interpretation including meanings implied from the specification as well as meanings understood by those skilled in the art and/or as defined in dictionaries, treatises, etc. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment and terminology was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method for evaluating the condition of data for purposes of applying data analytics options, the method comprising:
collecting data to evaluate a condition of the data for supporting a plurality of data analytics options;
determining, for each data analytics option, a plurality of a group of data indices, the group consisting of: a volume index measuring the amount of data for meaningful analysis and model building, a history index for measuring the amount of historical data available to capture necessary cycle data, a variety index for measuring the variety and type of data, a veracity index for measuring the quality of the data, a value index for measuring the information gain provided by the data, and combinations thereof; and
determining a data readiness score, wherein determining the data readiness score encompasses scaling, for each of the data analytics options, the plurality of the group of data indices.

2. The computer-implemented method according to claim 1, further comprising:
determining, for each data analytics option, all the plurality of the group of data indices; and
determining the data readiness score based upon scaling, for each data analytics options, all the plurality of the group of data indices.

3. The computer-implemented method according to claim 1, further comprising generating a data readiness report that includes the data readiness score.

4. The computer-implemented method according to claim 3, further comprising generating the data readiness report to include the plurality of the group of data indices.

5. The computer-implemented method according to claim 3, wherein the data readiness report is generated by a Data Readiness Module.

6. The computer-implemented method according to claim 5, further comprises preparing one or more insights based upon the plurality of the group of data indices, and including the one or more insights in the data readiness report.

7. The computer-implemented method according to claim 5, further comprising preparing one or more visual aids for the plurality of the group of data indices, and including the one or more visual aids in the data readiness report.

8. The computer-implemented method according to claim 3, further comprising:
preparing, for at least one of the group of data indices, one or more insights;
preparing, for at least one of the group of data indices, one or more visual aids; and
including in the data readiness report at least one of the one or more insights and the one or more visual aids.

9. The computer-implemented method according to claim 1, further comprising utilizing a data requirements matrix which sets forth for each of the plurality of data analytics options the minimum threshold data requirements for each of the data indices group.

10. The computer-implemented method according to claim 9, further comprising:
providing domain specific business objectives to account for a potential value of each of the plurality of data analytics options; and
calculating, for each of the plurality of data analytics options, the information gain.

11. The computer-implemented method according to claim 10, wherein providing domain specific business objectives to account for the potential value of each of the plurality of data analytics options comprises applying, for each of the plurality of data analytics options, a scaling factor to one or more of the group of data indices.

12. The computer-implemented method according to claim 11, wherein calculating, for each of the plurality of data analytics options, the information gain comprises, accounting, for each data analytics option, the minimum threshold data requirements and the scaling factor for each of the data indices group.

13. The computer-implemented method according to claim 10, further comprising:
monitoring and graphing the data readiness score over a time period; and
monitoring and graphing each of the data indices over the time period.

14. A non-transitory computer readable medium comprising instructions that, when executed by at least one hardware processor, configure the at least one hardware processor to:
collect data to evaluate its condition for supporting a plurality of data analytics options;
determine, for each data analytics option, a plurality of a group of data indices consisting of: a volume index measuring the amount of data for meaningful analysis and model building, a history index for measuring the amount of historical data available to capture necessary cycle data, a variety index for measuring the variety and type of data, a veracity index for measuring the quality of the data, a value index for measuring the information gain provided by the data, and combinations thereof; and
determine a data readiness score, wherein determining the data readiness score encompasses scaling, for each of the data analytics options, the plurality of the group of data indices.

15. The non-transitory computer readable medium according to claim 14, further comprising instructions that, when executed by at least one hardware processor, configure the at least one hardware processor to:
determine, for each data analytics option, all the plurality of the group of data indices; and
determine the data readiness score based upon scaling, for each data analytics options, all the plurality of the group of data indices.

16. The non-transitory computer readable medium according to claim 14, further comprising instructions that, when executed by at least one hardware processor, configure the at least one hardware processor to generate a data readiness report that includes the data readiness score and the plurality of the group of data indices.

17. The non-transitory computer readable medium according to claim 14, further comprising instructions that, when executed by at least one hardware processor, configure the at least one hardware processor to:
prepare, for at least one of the group of data indices, one or more insights;
prepare, for at least one of the group of data indices, one or more visual aids; and
include in the data readiness report at least one of the one or more insights and the one or more visual aids.

18. The non-transitory computer readable medium according to claim 14, further comprising instructions that, when executed by at least one hardware processor, configure the at least one hardware processor to:
generate a data requirements matrix which sets forth for each of the plurality of data analytics options the minimum threshold data requirements for each of the data indices group;
apply, for each of the plurality of data analytics options, a scaling factor to one or more of the group of data indices to account for domain specific business objectives of the data analytics options; and
calculate, for each of the plurality of data analytics options, the information gain,
wherein calculating, for each of the plurality of data analytics options, the information gain comprises, accounting, for each data analytics option, the minimum threshold data requirements and the scaling factor for each of the data indices group.

19. A computer-implemented system to evaluate the condition of data for the purpose of applying data analytics comprising:
a memory storage device storing program instructions; and
a hardware processor coupled to said memory storage device, the hardware processor, in response to executing said program instructions, is configured to:
collect data to evaluate its condition for supporting a plurality of data analytics options;
determine, for each data analytics option, a plurality of a group of data indices consisting of: a volume index measuring the amount of data for meaningful analysis and model building, a history index for measuring the amount of historical data available to capture necessary cycle data, a variety index for measuring the variety and type of data, a veracity index for measuring the quality of the data, a value index for measuring the information gain provided by the data, and combinations thereof;
determine a data readiness score, wherein determining the data readiness score encompasses scaling, for each of the data analytics options, the plurality of the group of data indices.

20. The computer-implemented system according to claim 19, wherein the hardware processor, in response to executing programing instructions, is further configured to:
determine, for each data analytics option, all the plurality of the group of data indices;
determine the data readiness score based upon scaling, for each data analytics options, all the plurality of the group of data indices;
prepare, for at least one of the group of data indices, one or more insights;
prepare, for at least one of the group of data indices, one or more visual aids;
include in a data readiness report at least one of the one or more insights and the one or more visual aids;
generate a data requirements matrix which sets forth for each of the plurality of data analytics options the minimum threshold data requirements for each of the data indices group;
apply, for each of the plurality of data analytics options, a scaling factor to one or more of the group of data indices to account for domain specific business objectives of the data analytics options; and
calculate, for each of the plurality of data analytics options, the information gain, wherein calculating, for each of the plurality of data analytics options, the information gain comprises, accounting, for each data analytics option, the minimum threshold data requirements and the scaling factor for each of the data indices group.
